(19) United States
(12) Patent Application Publication
(10) Pub. No.: US 2011/0044039 A1
(43) Pub. Date: Feb. 24, 2011

(54) LED LAMP CONSTRUCTION WITH INTEGRAL APPEARANCE

(75) Inventors: CHIA-TIN CHUNG, Toufen Township (TW); Hsin-Yuan Peng, Xinwu Township (TW)

Correspondence Address: KILE PARK GOEKJIAN REED & MCMANUS, 1200 NEW HAMPSHIRE AVE, NW, SUITE 570, WASHINGTON, DC, 20036, US

(73) Assignee: Paragon Semiconductor Lighting Technology Co., Ltd.

(21) Appl. No.: 12/622,619

(22) Filed: Nov. 20, 2009

(30) Foreign Application Priority Data
Aug. 19, 2009 (TW) 098215281

(51) Int. Cl. F21V 7/00; F21V 19/00; F21V 29/00

(52) U.S. Cl. 362/235; 362/382; 362/294

(57) ABSTRACT

An LED lamp construction with integral appearance includes an outer shell unit, a conductive retaining unit, a light-emitting module, a circuit unit and a heat-dissipating unit. The outer shell unit has an integral shell body and a receiving space formed in the shell body. The conductive retaining unit is disposed on a bottom side of the shell body. The light-emitting module is disposed on a top side of the shell body. The circuit unit is received in the receiving space and electrically connected between the light-emitting module and the conductive retaining unit. The heat-dissipating unit is disposed on a bottom side of the light-emitting module. Hence, the manufacturing cost is decreased and the manufacturing method is simple in the present invention due to the integral appearance of the present invention.

### CROSS-REFERENCE TO RELATED APPLICATION

This application claims priority under 35 U.S.C. §119 to Taiwan Patent Application No. 098215281, filed on Aug. 19, 2009, in the Taiwan Intellectual Property Office, the entire contents of which are hereby incorporated by reference.

### BACKGROUND OF THE INVENTION

1. Field of the Invention

The present invention relates to an LED lamp construction, in particular, to an LED lamp construction with integral appearance.

2. Description of Related Art

The invention of the lamp greatly changed the style of building construction and the living style of human beings, allowing people to work during the night. Without the invention of the lamp, we may stay in the living conditions of ancient civilizations.

Various lamps such as incandescent bulbs, fluorescent bulbs, power-saving bulbs and etc. have been intensively used for indoor illumination. These lamps commonly have the disadvantages of quick attenuation, high power consumption, high heat generation, short working life, high fragility, and being not recyclable. Further, the rapid flow of electrons (about 120 per second) through the electrodes of a regular fluorescent bulb causes an unstable current at the onset of lighting a fluorescent bulb, resulting in a flash of light that is harmful to the sight of the eyes. In order to eliminate this problem, a high frequency electronic ballast may be used. When a fluorescent or power-saving bulb is used with high frequency electronic ballast, it saves about 20% of the consumption of power and eliminates the problem of flashing. However, the high frequency electronic ballast is not detachable when installed in a fluorescent or power-saving bulb, the whole lamp assembly becomes useless if the bulb is damaged. Furthermore, because a fluorescent bulb contains a mercury coating, it may cause pollution to the environment when thrown away after damage. Hence, LED lamp or LED tube is created in order to solve the above-mentioned questions of the prior lamp.

### SUMMARY OF THE INVENTION

In view of the aforementioned issues, the present invention provides an LED lamp construction with integral appearance. The manufacturing cost is decreased and the manufacturing method is simple in the present invention due to the integral appearance of the present invention.

To achieve the above-mentioned objectives, the present invention provides an LED lamp construction with integral appearance, including: an outer shell unit, a conductive retaining unit, a light-emitting module, a circuit unit and a heat-dissipating unit. The outer shell unit has an integral shell body and a receiving space formed in the shell body. The conductive retaining unit is disposed on a bottom side of the shell body. The light-emitting module is disposed on a top side of the shell body. The circuit unit is received in the receiving space and electrically connected between the light-emitting module and the conductive retaining unit. The heat-dissipating unit is disposed on a bottom side of the light-emitting module.

To achieve the above-mentioned objectives, the present invention provides an LED lamp construction with integral appearance, including: an outer shell unit, a conductive retaining unit, a light-emitting module and a heat-dissipating unit. The outer shell unit has an integral shell body and a receiving space formed in the shell body. The conductive retaining unit is disposed on a bottom side of the shell body. The light-emitting module is disposed on a top side of the shell body and electrically connected to the conductive retaining unit. The heat-dissipating unit is disposed on a bottom side of the light-emitting module.

Therefore, the outer shell unit has a plurality of heat-dissipating holes passing through the shell body, so that the heat-dissipating efficiency of the present invention is increased by the design of the heat-dissipating holes. In addition, the heat-dissipating unit has a plurality of heat-dissipating posts extended downwards from the bottom side of the light-emitting module, so that heat generated by the light-emitting module can be dissipated by the heat-dissipating posts.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1A is a perspective, schematic view of the LED lamp construction with integral appearance according to the present invention;

FIG. 1B is a cross-sectional, schematic view of the LED lamp construction with integral appearance according to the present invention;

FIGS. 2A to 5B are schematic views of the light-emitting module of the first embodiment according to the present invention, at different stages of the packaging processes, respectively;

FIGS. 6A to 6C are schematic views of the light-emitting module of the second embodiment according to the present invention, at different stages of the packaging processes, respectively; and

FIG. 7 is a cross-sectional, schematic view of the light-emitting module of the third embodiment according to the present invention.

### DETAILED DESCRIPTION OF THE PREFERRED EMBODIMENTS

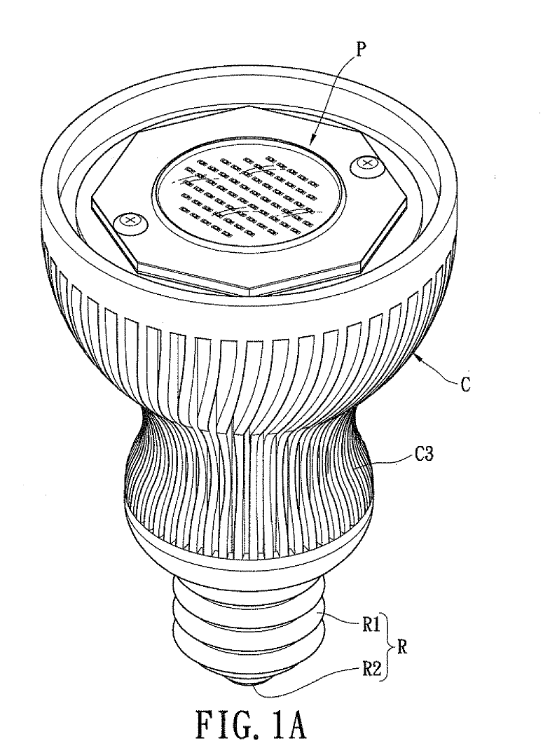

Referring to FIGS. 1A and 1B (FIG. 1B is a cross-sectional view of FIG. 1A), the present invention provides an LED lamp construction with integral appearance, including: an outer shell unit C, a conductive retaining unit R, a light-emitting module P, a circuit unit V and a heat-dissipating unit F.

The outer shell unit C has an integral shell body C1, a receiving space C2 formed in the shell body C1, a plurality of fins C3 integrally formed on an outer surface of the shell body C1 and a plurality of heat-dissipating holes C4 passing through the shell body C1. In addition, the shell body C1 can be made of plastic material to form a plastic body by injection molding, so that the LED lamp construction of the present invention can show an integral appearance.

The conductive retaining unit R is disposed on a bottom side of the shell body C1, and the conductive retaining unit R has a conductive retaining body R1 with screw appearance and a conductive base R2 disposed under the conductive retaining body R1 and insulated from the conductive retaining body R1. In addition, the LED lamp construction can be electrically positioned in a power source socket (not shown) by the conductive retaining unit R.

Moreover, the circuit unit V is received in the receiving space C2 and electrically connected between the light-emitting module P and the conductive retaining unit R. For example, the circuit unit V can be a transformer that has two electrodes V1 respectively electrically connected to the conductive retaining body R1 and the conductive base R2. In addition, the first embodiment of the present invention further includes a plurality of wires W respectively electrically between the light-emitting module P and the circuit unit V and between circuit unit V and the conductive retaining unit R. Hence, the LED lamp construction can be electrically positioned in a power source socket (not shown) by the conductive retaining unit R and the power of the power source socket is guided to the light-emitting module P by the wires W.

The light-emitting module P is disposed on a top side of the shell body C1, and the heat-dissipating unit F is disposed on a bottom side of the light-emitting module P. For example, in the first embodiment, a platform is created on the shell body C1, and the light-emitting module P is fixed on the platform of the shell body C1 by screws. In addition, the heat-dissipating unit F has a plurality of heat-dissipating posts F1 extended downwards from the bottom side of the light-emitting module P. The heat-dissipating posts F1 can be made of metal, and each heat-dissipating post F1 has any shape that is embedded into the receiving space C2. Hence, heat generated by the light-emitting module P can be dissipated by the heat-dissipating posts F1, and the heat-dissipating efficiency of the present invention is increased by the design of the heat-dissipating holes C4.

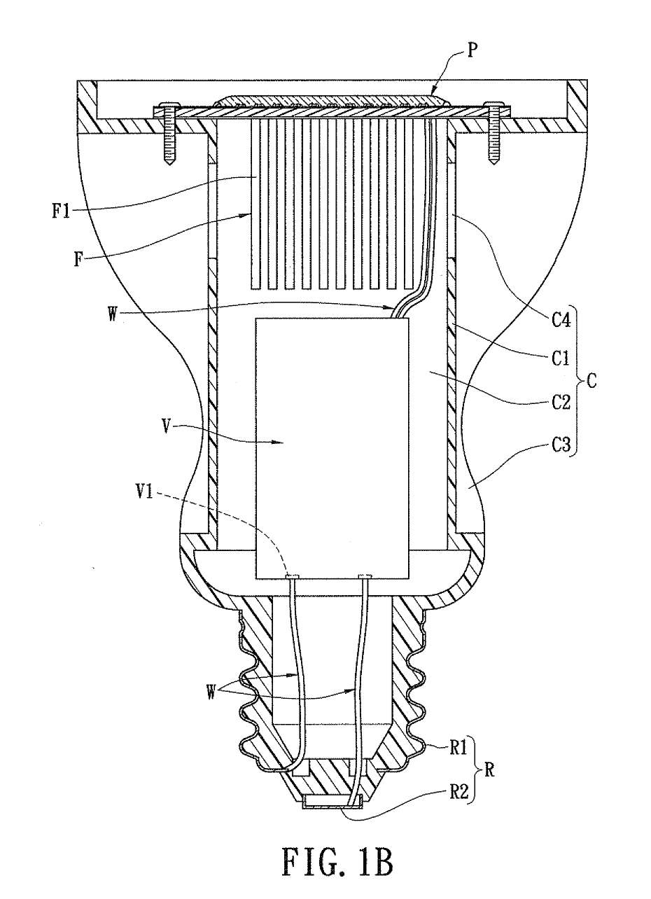

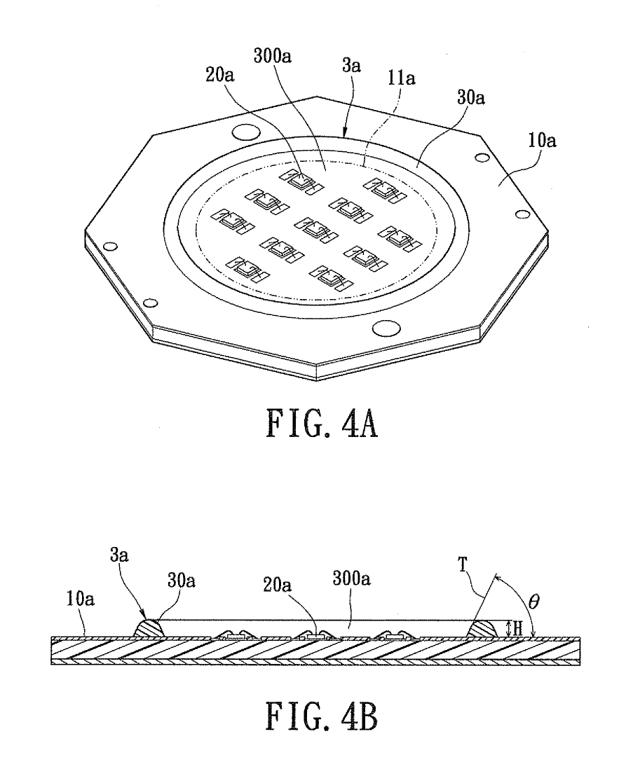

Referring to FIGS. 2A and 5B, the detail descriptions of the method for manufacturing the light-emitting module P in the first embodiment of the present invention are shown as follows (the step S100 to the step S108):

Referring to FIGS. 2A and 2B (FIG. 2B is a cross-section of FIG. 2A), the method includes providing a substrate unit 1a that has a substrate body 10a and a chip-placing area 11a disposed on a top surface of the substrate body 10a (step S100). In addition, the substrate body 10a has a circuit substrate 100a, a heat-dissipating layer 101a disposed on a bottom surface of the circuit substrate 100a, a plurality of conductive pads 102a disposed on a top surface of the circuit substrate 100a, and an insulative layer 103a disposed on the top surface of the circuit substrate 100a in order to expose the conductive pads 102a. Hence, the heat-dissipating efficiency of the circuit substrate 100a is increased by using the heat-dissipating layer 101a, and the insulative layer 103a is a solder mask for exposing the conductive pads 102a only in order to achieve local soldering.

However, the above-mentioned definition of the substrate body 10a does not limit the present invention. Any types of substrate can be applied to the present invention. For example, the substrate body 10a can be a PCB (Printed Circuit Board), a flexible substrate, an aluminum substrate, a ceramic substrate, or a copper substrate.

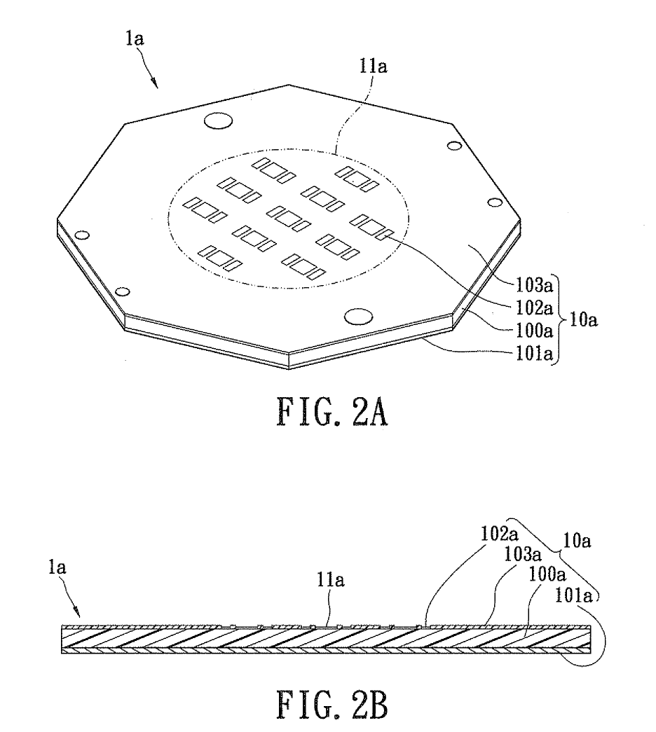

Referring to FIGS. 3A and 3B (FIG. 3B is a cross-section of FIG. 3A), the method includes electrically arranging a plurality of LED chips 20a on the chip-placing area 11a of the substrate unit 1a (step S102). In other words, designer can plan a predetermined chip-placing area 11a on the substrate unit 1a in advance, so that the LED chips 20a can be placed on the chip-placing area 11a of the substrate unit 1a. In the first embodiment, the LED chips 20a are electrically disposed on the chip-placing area 11a of the substrate unit 1a by wire bonding.

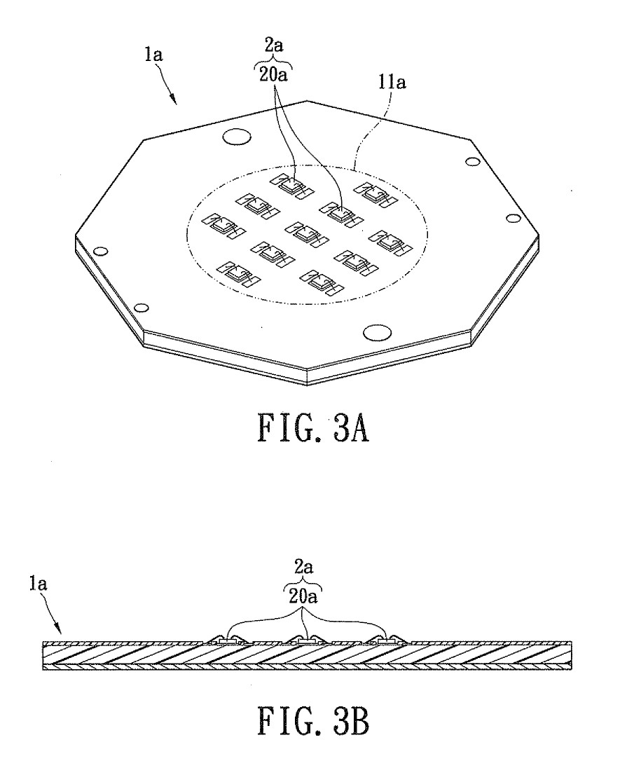

Referring to FIGS. 4A and 4B (FIG. 4B is a cross-section of FIG. 4A), the method includes surroundingly coating liquid resin (not shown) on the top surface of the substrate body 10a (step S104). In addition, the liquid resin can be coated on the substrate body 10a by any shapes according to different requirements (such as a circular shape, a square or a rectangular shape etc.). The thixotropic index of the liquid resin is between 4 and 6, the pressure of coating the liquid resin on the top surface of the substrate body 10a is between 350 kpa and 450 kpa, and the velocity of coating the liquid resin on the top surface of the substrate body 10a is between 5 mm/s and 15 mm/s. The liquid resin is surroundingly coated on the top surface of the substrate body 10a from a start point to a termination point, and the position of the start point and the position of the termination point are the same. Furthermore, after the step S104, the method includes hardening the liquid resin to form an annular reflecting resin body 30a, and the annular reflecting resin body 30a surrounding the LED chips 20a that are disposed on the chip-placing area 11a to form a resin position limiting space 300a above the chip-placing area 11a (step S106). In addition, the liquid resin is hardened by baking, the baking temperature is between 120° C. and 140° C., and the baking time is between 20 minute and 40 minute.

Moreover, the annular reflecting resin body 30a has an arc shape formed on a top surface thereof. The annular reflecting resin body 30a has a radius tangent T, and the angle θ of the radius tangent T relative to the top surface of the substrate body 10a is between 40° C. and 50° C. The maximum height H of the annular reflecting resin body 30a relative to the top surface of the substrate body 10a is between 0.3 mm and 0.7 mm, and the width of a bottom side of the annular reflecting resin body 30a is between 1.5 mm and 3 mm. The thixotropic index of the annular reflecting resin body 30a is between 4 and 6. In addition, the resin position limiting space 300a has a cross section that can be a circular shape, an elliptical shape or a polygonal shape (such as a square or a rectangular shape etc). In the first embodiment, the cross section of the resin position limiting space 300a is a circular shape.

Referring to FIGS. 5A and 5B (FIG. 5B is a cross-section of FIG. 5A), the method includes forming a translucent package resin body 40a on the top surface of the substrate body 10a in order to cover the LED chips 20a, and the position of the translucent package resin body 40a being limited in the resin position limiting space 300a (step S108). In addition, the annular reflecting resin body 30a can be a white thermohardening reflecting body (opaque resin) mixed with inorganic additive, and the top surface of the translucent package resin body 40a is convex.

In the first embodiment, each LED chip 20a can be a blue LED chip, and the translucent package resin body 40a can be a phosphor body. Hence, blue light beams L1 generated by the LED chips 20a (the blue LED chips) can pass through the translucent package resin body 40a (the phosphor body) to generate white light beams L2 that are similar to the light source generate by sun lamp.

In other words, the translucent package resin body 40a is limited in the resin position limiting space 300a by using the annular reflecting resin body 30a in order to control the usage quantity of the translucent package resin body 40a. In addition, the surface shape and the height of the translucent package resin body 40a can be adjusted by control the usage quantity of the translucent package resin body 40a in order to light-projecting angles of the white light beams L2. Moreover, the blue light beams L1 generated by the LED chips 20a can be reflected by an inner wall of the annular reflecting resin body 30a in order to increase the light-emitting efficiency of the LED lamp construction of the present invention.

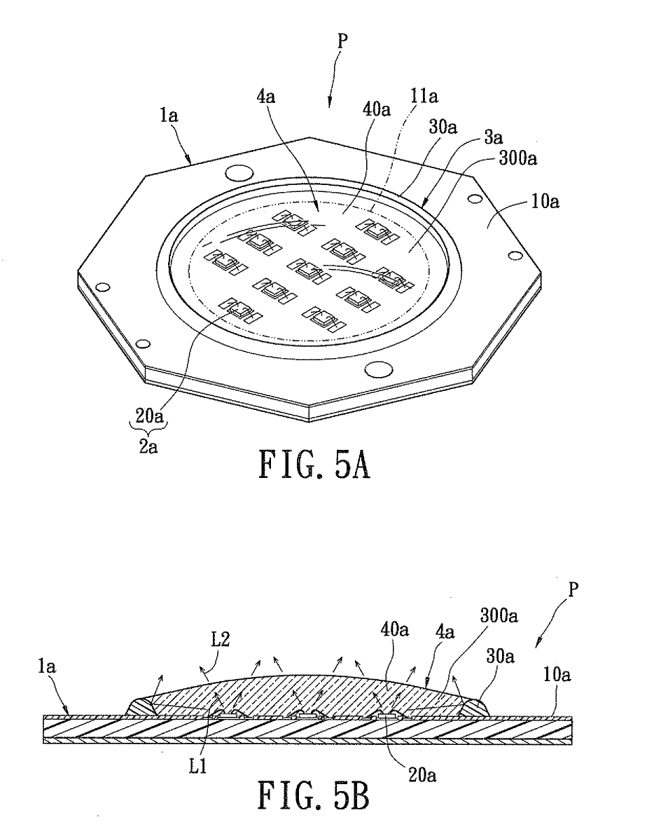

Referring to FIGS. 6A to 6C, the detail descriptions of the method for manufacturing the light-emitting module P in the second embodiment of the present invention are shown as follows (the step S200 to the step S208):

Referring to FIG. 6A, the method includes providing a substrate unit 1b that has a substrate body 10b and a chip-placing area 11b disposed on a top surface of the substrate body 10b (step S200). In addition, the substrate body 10b has a circuit substrate 100b, a heat-dissipating layer 101b disposed on a bottom surface of the circuit substrate 100b, a plurality of conductive pads 102b disposed on a top surface of the circuit substrate 100b, and an insulative layer 103b disposed on the top surface of the circuit substrate 100b in order to expose the conductive pads 102b.

Referring to FIG. 6A, the method includes surroundingly coating liquid resin (not shown) on the top surface of the substrate body 10b (step S202). In addition, the liquid resin can be coated on the substrate body 10b by any shapes according to different requirements (such as a circular shape, a square or a rectangular shape etc.). The thixotropic index of the liquid resin is between 4 and 6, the pressure of coating the liquid resin on the top surface of the substrate body 10b is between 350 kpa and 450 kpa, and the velocity of coating the liquid resin on the top surface of the substrate body 10b is between 5 mm/s and 15 mm/s. The liquid resin is surroundingly coated on the top surface of the substrate body 10b from a start point to a termination point, and the position of the start point and the position of the termination point are the same. Furthermore, after the step S202, the method includes hardening the liquid resin to form an annular reflecting resin body 30b, and the annular reflecting resin body 30b surrounding the LED chips 20b that are disposed on the chip-placing area 11b to form a resin position limiting space 300b above the chip-placing area 11b (step S204). In addition, the liquid resin is hardened by baking, the baking temperature is between 120° C. and 140° C., and the baking time is between 20 minute and 40 minute.

Moreover, the annular reflecting resin body 30b has an arc shape formed on a top surface thereof. The annular reflecting resin body 30b has a radius tangent T, and the angle θ of the radius tangent T relative to the top surface of the substrate body 10b is between 40° C. and 50° C. The maximum height H of the annular reflecting resin body 30b relative to the top surface of the substrate body 10b is between 0.3 mm and 0.7 mm, and the width of a bottom side of the annular reflecting resin body 30b is between 1.5 mm and 3 mm. The thixotropic index of the annular reflecting resin body 30b is between 4 and 6. In addition, the resin position limiting space 300b has a cross section that can be a circular shape, an elliptical shape or a polygonal shape (such as a square or a rectangular shape etc).

Referring to FIG. 6B, the method includes electrically arranging a plurality of LED chips 20b on the chip-placing area 11b of the substrate unit 1b (step S206). In other words, designer can plan a predetermined chip-placing area 11b on the substrate unit 1b in advance, so that the LED chips 20b can be placed on the chip-placing area 11b of the substrate unit 1b by wire bonding.

Referring to FIG. 6C, the method includes forming a translucent package resin body 40b on the top surface of the substrate body 10b in order to cover the LED chips 20b, and the position of the translucent package resin body 40b being limited in the resin position limiting space 300b (step S208). In addition, the annular reflecting resin body 30b can be a white thermohardening reflecting body (opaque resin) mixed with inorganic additive, and the top surface of the translucent package resin body 40b is convex.

In the second embodiment, each LED chip 20b can be a blue LED chip, and the translucent package resin body 40b can be a phosphor body. Hence, blue light beams L1 generated by the LED chips 20b (the blue LED chips) can pass through the translucent package resin body 40b (the phosphor body) to generate white light beams L2 that are similar to the light source generate by sun lamp.

Furthermore, referring to FIGS. 5A, 5B and 6C, the present invention provides a light-emitting module P by using the above-mentioned manufacturing methods. The light-emitting module P includes a substrate unit (1a, 1b), a light-emitting unit (2a, 2b), a light-reflecting unit (3a, 3b) and a package unit (4a, 4b).

The substrate unit (1a, 1b) has a substrate body (10a, 10b) and a chip-placing area (11a, 11b) disposed on a top surface of the substrate body (10a, 10b). The light-emitting unit (2a, 2b) has a plurality of LED chips (20a, 20b) electrically disposed on the chip-placing area (11a, 11b).

Moreover, the light-reflecting unit (3a, 3b) has an annular reflecting resin body (30a, 30b) surroundingly formed on the top surface of the substrate body (10a, 10h) by coating. The annular reflecting resin body (30a, 30b) surrounds the LED chips (20a, 20b) that are disposed on the chip-placing area (11a, 11b) to form a resin position limiting space (300a, 300h) above the chip-placing area (11a, 11b).

In addition, the package unit (4a, 4b) has a translucent package resin body (40a, 40b) disposed on the top surface of the substrate body (10a, 10h) in order to cover the LED chips (20a, 20b). The position of the translucent package resin body (40a, 40b) is limited in the resin position limiting space (300a, 300b).

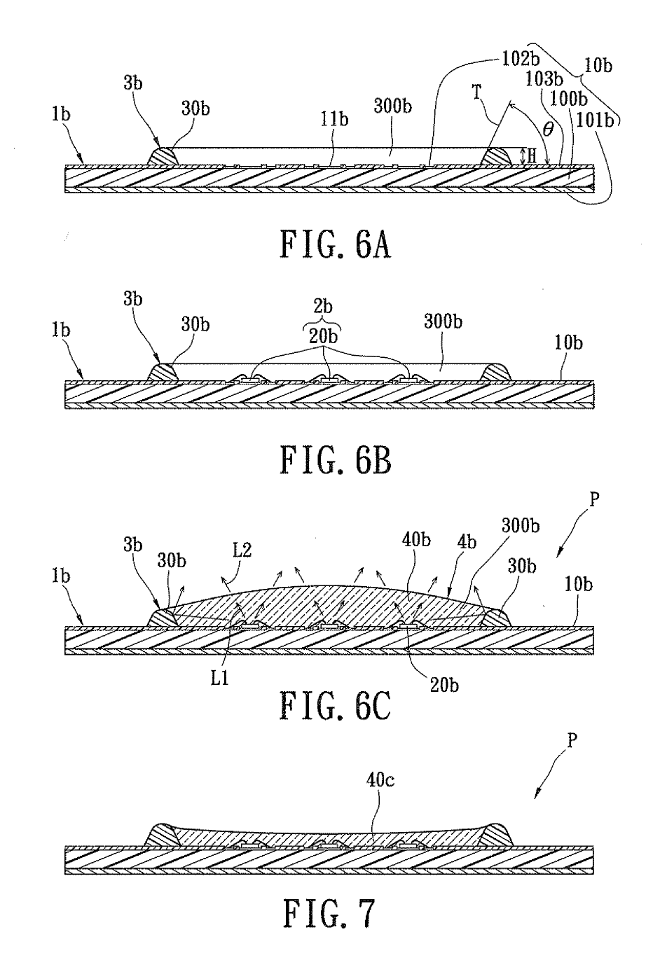

Referring to FIG. 7, the difference between the third embodiment of the light-emitting module and the above-mentioned embodiments of the light-emitting module is that: the top surface of the translucent package resin body 40c is concave. Of course, the top surface of the translucent package resin body 40c also can be plane (not shown).

In conclusion, the manufacturing cost is decreased and the manufacturing method is simple in the present invention due to the integral appearance of the present invention. Moreover, the outer shell unit has a plurality of heat-dissipating holes passing through the shell body, so that the heat-dissipating efficiency of the present invention is increased by the design of the heat-dissipating holes. In addition, the heat-dissipating unit has a plurality of heat-dissipating posts extended downwards from the bottom side of the light-emitting module, so that heat generated by the light-emitting module can be dissipated by the heat-dissipating posts.

Furthermore, the present invention can form an annular reflecting resin body (an annular white resin body) with any shapes by coating method. In addition, the position of a translucent package resin body such as phosphor resin can be limited in the resin position limiting space by using the annular reflecting resin body, and the shape of the translucent package resin body can be adjusted by using the annular reflecting resin body. Therefore, the present invention can apply to increase light-emitting efficiency of LED chips and control light-projecting angle of LED chips. In other words, the translucent package resin body is limited in the resin position limiting space by using the annular reflecting resin body in order to control the usage quantity of the translucent package resin body. In addition, the surface shape and the height of the translucent package resin body can be adjusted by control the usage quantity of the translucent package resin body in order to light-projecting angles of the white light beams. Moreover, the blue light beams generated by the LED chips can be reflected by an inner wall of the annular reflecting resin body in order to increase the light-emitting efficiency of the LED lamp construction of the present invention.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. An LED lamp construction with integral appearance, comprising:
an outer shell unit having an integral shell body and a receiving space formed in the shell body;
a conductive retaining unit disposed on a bottom side of the shell body;
a light-emitting module disposed on a top side of the shell body;
a circuit unit received in the receiving space and electrically connected between the light-emitting module and the conductive retaining unit; and
a heat-dissipating unit disposed on a bottom side of the light-emitting module.

2. The LED lamp construction according to claim 1, wherein the shell body is a plastic body, and the outer shell unit has a plurality of fins integrally formed on an outer surface of the shell body and a plurality of heat-dissipating holes passing through the shell body.

3. The LED lamp construction according to claim 1, wherein the conductive retaining unit has a conductive retaining body with screw appearance and a conductive base disposed under the conductive retaining body and insulated from the conductive retaining body.

4. The LED lamp construction according to claim 3, wherein the circuit unit is a transformer that has two electrodes respectively electrically connected to the conductive retaining body and the conductive base.

5. The LED lamp construction according to claim 1, wherein the light-emitting module has a substrate unit, a light-emitting unit electrically disposed on the substrate unit, a translucent package resin body disposed on a top surface of the substrate unit in order to cover the light-emitting unit, and the light-emitting unit has at least one LED chip.

6. The LED lamp construction according to claim 1, wherein the light-emitting module comprises:
a substrate unit having a substrate body and a chip-placing area disposed on a top surface of the substrate body;
a light-emitting unit having a plurality of LED chips electrically disposed on the chip-placing area of the substrate unit;
a light-reflecting unit having an annular reflecting resin body surroundingly formed on the top surface of the substrate body by coating; and
a package unit having a translucent package resin body disposed on the top surface of the substrate body in order to cover the LED chips.

7. The LED lamp construction according to claim 6, wherein the annular reflecting resin body surrounds the LED chips to form a resin position limiting space above the substrate body, and the position of the translucent package resin body is limited in the resin position limiting space.

8. The LED lamp construction according to claim 6, wherein the substrate body has a circuit substrate, a heat-dissipating layer disposed on a bottom surface of the circuit substrate, a plurality of conductive pads disposed on a top surface of the circuit substrate, and an insulative layer disposed on the top surface of the circuit substrate in order to expose the conductive pads.

9. The LED lamp construction according to claim 6, wherein the annular reflecting resin body has an arc shape formed on a top surface thereof, the annular reflecting resin body has a radius tangent and the angle of the radius tangent relative to the top surface of the substrate body is between 40° C. and 50° C., the maximum height of the annular reflecting resin body relative to the top surface of the substrate body is between 0.3 mm and 0.7 mm, the width of a bottom side of the annular reflecting resin body is between 1.5 mm and 3 mm, the thixotropic index of the annular reflecting resin body is between 4 and 6, and the annular reflecting resin body is a white thermohardening reflecting body mixed with inorganic additive.

10. The LED lamp construction according to claim 1, wherein the heat-dissipating unit has a plurality of heat-dissipating posts extended downwards from the bottom side of the light-emitting module.

11. An LED lamp construction with integral appearance, comprising:
an outer shell unit having an integral shell body and a receiving space formed in the shell body;
a conductive retaining unit disposed on a bottom side of the shell body;
a light-emitting module disposed on a top side of the shell body and electrically connected to the conductive retaining unit; and
a heat-dissipating unit disposed on a bottom side of the light-emitting module.

12. The LED lamp construction according to claim 11, wherein the shell body is a plastic body, and the outer shell unit has a plurality of fins integrally formed on an outer surface of the shell body and a plurality of heat-dissipating holes passing through the shell body.

13. The LED lamp construction according to claim 11, wherein the conductive retaining unit has a conductive retaining body with screw appearance and a conductive base disposed under the conductive retaining body and insulated from the conductive retaining body.

14. The LED lamp construction according to claim 13, wherein the light-emitting module has two electrodes respectively electrically connected to the conductive retaining body and the conductive base.

15. The LED lamp construction according to claim 11, wherein the light-emitting module has a substrate unit, a light-emitting unit electrically disposed on the substrate unit, a translucent package resin body disposed on a top surface of the substrate unit in order to cover the light-emitting unit, and the light-emitting unit has at least one LED chip.

16. The LED lamp construction according to claim 11, wherein the light-emitting module comprises:
a substrate unit having a substrate body and a chip-placing area disposed on a top surface of the substrate body;
a light-emitting unit having a plurality of LED chips electrically disposed on the chip-placing area of the substrate unit;
a light-reflecting unit having an annular reflecting resin body surroundingly formed on the top surface of the substrate body by coating; and
a package unit having a translucent package resin body disposed on the top surface of the substrate body in order to cover the LED chips.

17. The LED lamp construction according to claim 16, wherein the annular reflecting resin body surrounds the LED chips to form a resin position limiting space above the substrate body, and the position of the translucent package resin body is limited in the resin position limiting space.

18. The LED lamp construction according to claim 16, wherein the substrate body has a circuit substrate, a heat-dissipating layer disposed on a bottom surface of the circuit substrate, a plurality of conductive pads disposed on a top surface of the circuit substrate, and an insulative layer disposed on the top surface of the circuit substrate in order to expose the conductive pads.

19. The LED lamp construction according to claim 16, wherein the annular reflecting resin body has an arc shape formed on a top surface thereof, the annular reflecting resin body has a radius tangent and the angle of the radius tangent relative to the top surface of the substrate body is between 40° C. and 50° C., the maximum height of the annular reflecting resin body relative to the top surface of the substrate body is between 0.3 mm and 0.7 mm, the width of a bottom side of the annular reflecting resin body is between 1.5 mm and 3 mm, the thixotropic index of the annular reflecting resin body is between 4 and 6, and the annular reflecting resin body is a white thermohardening reflecting body mixed with inorganic additive.

20. The LED lamp construction according to claim 11, wherein the heat-dissipating unit has a plurality of heat-dissipating posts extended downwards from the bottom side of the light-emitting module.
